(19) United States
(12) Patent Application Publication
(10) Pub. No.: US 2009/0113730 A1
(43) Pub. Date: May 7, 2009

(54) Ergonomic Razor Handle Provided With An Improved Grip

(75) Inventors: Yiannis Psimadas, Vrilissia-Athens (GR); Spiros Gratsias, Kypseli-Athens (GR); Dimitris Efthimiadis, Nea Kypseli-Athens (GR)

Correspondence Address: JONES DAY, 222 EAST 41ST ST, NEW YORK, NY, 10017, US

(73) Assignee: BIC-VIOLEX SA, Attiki (FR)

(21) Appl. No.: 11/994,028

(22) PCT Filed: Jun. 28, 2005
(86) PCT No.: PCT/EP2005/007996

§ 371 Date: Dec. 27, 2007

(51) Int. Cl. B26B 21/52

(52) U.S. Cl. 30/526

(57) ABSTRACT

A handle provided with an improved grip structure for a wet or safety razor, comprising a rigid plastic part (5) and a compressible part characterized in that said handle comprises bowed ribs (6,7) provided on the upper side of the handle in the vicinity of the razor head, the centre of which are aligned along the length of the handle and provided backwards.

### FIELD OF THE INVENTION

The present invention relates to a wet or safety razor. The invention particularly relates to an ergonomic handle provided with an improved grip structure for a wet or safety razor.

### BACKGROUND OF THE INVENTION

Many types of wet or safety razors (referred hereinafter as safety razors) are known in the art. Razors usually comprise a handle portion, at the front end of which a razor blade unit comprising one or more blades is disposed.

The structure of the handle portion is important for an optimal position of the grip, providing an optimal shaving angle to one or more blades with respect to the surface of skin. Gripping pads or ribs have been provided on the surface of the handles.

However, many known types of handles are limited in their gripping properties when the handle is used in a soapy and watery environment. Thus, although the gripping pads or ribs are made from an elastomeric compressible material, their shape and/or size do not facilitate shaving, particularly precision shaving, more particularly when the index finger of the user guides the razor blade unit. When the finger slips on the side of the handle, the blades are pushed laterally, and the user may cut himself.

Although some known types of handles make it possible to obtain a good gripping, research is still going on into handles with even better qualities, particularly as regards precision shaving where the index finger has an essential role.

EP-A-0 894 040 discloses a handle provided with an operating device on the upper side of the handle in the vicinity of the razor head. The said operating device is provided with short ribs which are straight on some drawings, and look curved on other drawings.

EP-A-0 402 105 discloses a handle provided with an actuator comprising short ribs on the upper side of the handle in the vicinity of the razor head.

### SUMMARY OF THE INVENTION

Now the applicant has designed a new type of handles which are provided with bowed rubber ribs provided on the upper side of the handle in the vicinity of the razor head.

It has been noted in a surprising and unexpected fashion that the use of the new type of handles of the invention allows the razor blade unit to be precisely guided with the result that a very good shaving is obtained on difficult surfaces of the skin such as under the nose.

### DESCRIPTION OF THE PREFERRED EMBODIMENTS

A subject of the present application is therefore a handle provided with an improved grip structure for a wet or safety razor, comprising a rigid plastic part and a compressible part characterized in that said handle comprises bowed ribs provided on the upper side of the handle in the vicinity of the razor head, the centre of which are aligned along the length of the handle and provided backwards.

The bowed ribs may be made of rigid plastic material or preferably of rubber material.

The bowed ribs seen from above look like arcs of a circle, generally of about 70 to 200 degrees of angle, notably between 90 and 180, preferably between 100 and 170, more preferably between 120 and 160.

One or more ribs may have a shape of a full circle. A sucker effect may thus be obtained, providing a further gripping effect to the user during shaving.

The mean radius of such ribs may be from 0.5 to 1.5, preferably from 0.6 to 1.2, more preferably from 0.65 to 1.05 cm.

In the system of the present invention, the term “rubber” indicates preferably an elastomeric plastic material, more preferably a mouldable elastomeric material, allowing for ample compression by the user while not requiring an excessive force. Examples of such materials are for example any elastomeric composition known in the art and of any elastomeric hardness range, especially those suitable for making a grip portion, and those that are in the Shore A hardness range. This includes elastomers and thermoplastic elastomers, as well as blends thereof. Suitable elastomers include nitrile rubbers (NBR), styrene butadiene rubbers (SDR), ethylene-propylene terpolymers (EPDM), and (compatible) mixtures thereof. Examples of suitable thermoplastic elastomers include styrene block copolymers, e.g. styrene-butylene block copolymers (SBS), styrene-ethylene-butylene block copolymers (SEBS), thermoplastic polyurethanes, polyether block amides, copolyesters, thermoplastic polyolefins (EPDM/PP, NBR/PP . . . ), and (compatible) blends thereof. Moreover, said elastomeric material may contain one or more additives. Examples of additives include chemicals commonly classed as antioxidants, UV-stabilisers, adhesion modifiers, smell reducers and other such materials that are known to those skilled in the art. Additives improve the processing of said material, enhance its shelf-life and service durability, improve the adhesion to substrate “polymeric supports” that are not inherently inter-compatible and delay inherent sensory defects, such as the inherent typical smell of elastomers and elastomeric compounds.

By “in the vicinity of the razor head”, is meant that the whole of the bowed ribs is provided within less than 5.5 cm from the blade or from the rear blade, preferably between 5.2 cm and 1.0 cm, more preferably between 4.9 cm and 1.5 cm, particularly between 4.5 cm and 2.0 cm.

The opening of the arcs may be provided towards the blades. However, in preferential conditions, the opening is provided towards the back of the handle as represented on the figures.

In other preferential conditions, the bowed ribs are provided on a rigid plastic surface of the handle. The number of bowed ribs is from 1 to 12, notably from 2 to 10, preferably 3 to 8, more preferably about 7.

Though the ribs may be provided perpendicular to the surface of the handle, in other preferential conditions, the ribs are slightly inclined towards the front of the handle at an angle of about 75° from the surface of the handle, for example between 60° and 80°.

The height of each rib may be constant. However, under preferred conditions for implementing the invention, the height of a given rib progressively decreases from a greater height at about the middle of the handle seen from above, to a smaller height as the rib extends outwards.

The height of each rib may be constant. However, under preferred conditions for implementing the invention, the height of a given rib progressively increases from a lower height at about the middle of the handle seen from above, to a greater height as the rib extends outwards.

The height of the ribs may also be constant. However, under preferred conditions for implementing the invention, the height or the maximum height of each next rib progressively increases from a smaller height backwards of the handle, to a greater height towards the blades.

Under other preferred conditions for implementing the invention, the height or the maximum height of each next rib progressively decreases from a greater height backwards of the handle, to a lower height towards the blades.

The length of the ribs may be constant. However, under other preferred conditions for implementing the invention, the length of each rib progressively increases from a smaller length backwards of the handle, to a greater length towards the blades. The greater length may be about 150% of the smaller length. Under other preferred conditions for implementing the invention, the length of each rib progressively increases from a smaller length backwards of the handle, to a greater length towards the blades and then progressively decreases to a smaller length.

The longitudinal spacing between two adjacent ribs is from 1.0 to 3.6, preferably 1.4 to 2.6, notably 1.6 to 2.0 mm.

The longitudinal thickness of a rib is from 1.0 to 4.0, preferably 1.5 to 3.0, more preferably 2 to 2.5 mm.

The applicant has also discovered that the slipping prevention effect of the above bowed ribs may be enhanced by a combination of rigid plastic ribs and of rubber ribs.

A sequence of plastic ribs and of rubber ribs may be provided. Preferably, the ribs are grouped according to the nature of the material used for their manufacture, for example plastic ribs and then rubber ribs.

Under preferred conditions for implementing the invention, rigid plastic bowed ribs are provided on the upper side of the handle close to the razor head, between rubber ribs and a cartridge equipped with the blades. In such a case, the length of each rigid plastic rib preferably progressively decreases from a greater length backwards of the handle, to a smaller length towards the blades.

The general structure of the rigid plastic bowed ribs is preferably the same as that of the rubber ribs.

In other preferential conditions, the number of bowed plastic ribs is from 2 to 4, preferably 3.

In further preferential conditions, the number of bowed rubber ribs is from 3 to 6, preferably 4.

The handle of the invention has a composite structure comprising a substantially rigid backbone of an injected moulded thermoplastic, non elastomeric material and a flexible part made of an injected moulded elastomeric material. Some places of the surface of the handle are constituted by the non elastomeric material and the others by the elastomeric material.

Under preferred conditions for implementing the invention, the present handle is obtained in a two step process.

A subject of the present invention is also a method for making a razor handle as disclosed above comprising moulding a backbone portion of a rigid plastic material, and moulding an elastomeric grip portion on said backbone portion, wherein bowed ribs are provided on the upper side of the handle.

Under preferred conditions for implementing the invention, bowed rubber ribs are provided and channels are provided in the backbone portion of the handle in the vicinity of the razor head such that the bowed rubber ribs may be created by feeding the elastomeric material from below the plastic rigid surface, through the channel holes opened on the upper surface of the handle. Bowed rubber ribs provided on a rigid plastic surface of the handle are thus obtained.

The handles according to the invention have advantageous properties because of the bowed ribs provided on the upper side of the handle in the vicinity of the razor head.

The bowed ribs prevent the index finger from slipping during precision shaving, especially when they are made of rubber.

This slipping prevention effect is enhanced by combining rubber ribs and rigid plastic ribs provided on the upper side of the handle close to the razor head, notably plastic ribs provided between the rubber ribs and a cartridge equipped with the blades.

Also, a handle provided with such an arrangement of bowed ribs shaped and dimensioned as described above provide the user with an improved tactile feel as well, improving the controllability and the grip-ability of the razor especially in wet and humid environments.

A safety razor having a handle, which is shaped as described above, ensures an optimal ergonomic grip by the user during precision shaving.

Preferred conditions for implementing the rubber ribs described above also apply to the other subjects of the invention envisaged above, particularly to the method for making a razor handle as disclosed above.

The scope of the invention can be understood better by referring to the description given below, the aim of which is to explain the advantages of the invention.

### DESCRIPTION OF THE DRAWINGS

FIG. 1 is a top plan view of the front part of a safety razor in accordance with one embodiment of a handle of the invention

FIG. 2 is a perspective view of the front part of a safety razor in accordance with one embodiment of a handle of the invention

FIG. 3 is a side elevation view of the front part of a safety razor in accordance with one embodiment of a handle of the invention

FIG. 4 is a longitudinal cross sectional view of the front part of a safety razor in accordance with one embodiment of a handle of the invention taken along AA′ of FIG. 1

FIG. 5 is a variant of the longitudinal cross sectional view of FIG. 4.

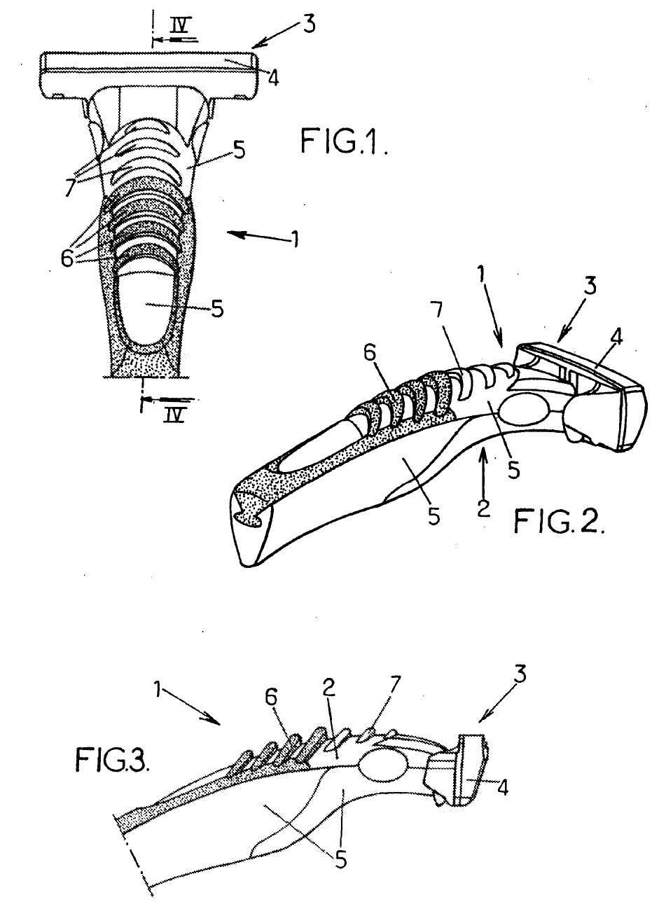

Referring to FIGS. 1-3, a safety razor 1 includes a gently curved handle 2 and a razor blade unit 3 having a rigid plastic body 4 provided with multiple blades fixed in the plastic body 4.

The handle 2 comprises a backbone 5 made of a mouldable rigid plastic material. The handle 2 is provided with a sequence of ribs grouped by nature, four bowed rubber ribs 6 towards the rear of the handle and three bowed rigid plastic ribs 7 towards the front of the handle.

The rubber ribs 6 are made from a mouldable elastomeric material allowing for compression by the user while not requiring an excessive force. Accordingly, the rubber ribs 6 tend to bend and compress and, therefore, to conform to the natural contour of the surface of the index finger to provide a reliable contact between the handle 2 and the user.

As seen on FIG. 1, the bowed rubber ribs 6 and the rigid plastic ribs 7 seen from above look like arcs of a circle, of about 110 degrees of angle, the centre of which are aligned along the length of the handle 2.

The opening of the arcs is provided towards the back of the handle.

Their general shape is a crescent. Therefore, the height of a given rib 6,7 progressively decreases from a greater height at about the middle of the handle, to a smaller height as the rib 6,7 extends outwards.

The length of each rigid plastic rib 7 progressively decreases from a greater length backwards of the handle 2, to a smaller length towards the razor blade unit 3, whereas the length of each rubber rib 6 progressively increases from a smaller length backwards of the handle, to a greater length towards the razor blade unit 3.

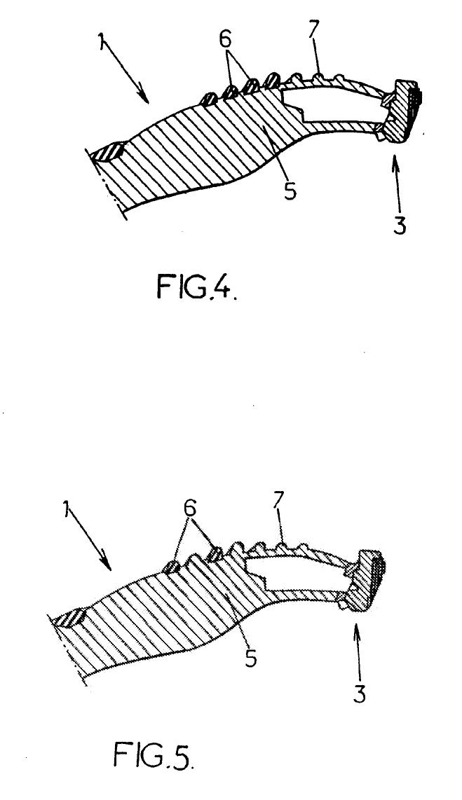

As seen on FIG. 3, the ribs are slightly inclined towards the front of the handle at an angle of about 75° from the surface of the handle. The maximum height of each next bowed rubber rib 6 progressively increases from a smaller height backwards of the handle, to a greater height towards the blades, and conversely for the rigid plastic ribs 7.

As seen on FIG. 4, the handle 2 comprises a backbone 5 made of a mouldable rigid plastic material. The handle 2 is provided with a sequence of ribs grouped according to the nature of the material used: four bowed rubber ribs 6 towards the rear of the handle, on the left, and three bowed rigid plastic ribs 7 towards the front of the handle, on the right.

As seen on FIG. 5, the handle 2 comprises a backbone 5 made of a mouldable rigid plastic material. The handle 2 is provided with a sequence of ribs but the ribs are not grouped according to the nature of the material used for their manufacture. The four ribs on the left are an alternation of plastic ribs and of rubber ribs whereas the last three ribs on the left all are rigid plastic ribs. The razor blade unit 3 is optimally guided by the index of the user during shaving.

1-14. (canceled)

15. A handle provided with an improved grip structure for a razor comprising a rigid plastic part and a compressible part characterized in that the handle comprises bowed ribs provided on an upper side of the handle in the vicinity of a razor head, the center of the ribs being aligned along the length of the handle and provided backwards.

16. The handle according to claim 15, wherein the bowed ribs include shapes like arcs of a circle having between about 90 and about 180 degrees of angle.

17. The handle according to claim 15, wherein one or more ribs have a shape of a full circle.

18. The handle according to any of claims 15-17, wherein the mean radius of the ribs is from 0.5 to 1.5 cm.

19. The handle according to claim 18, wherein the whole of the bowed ribs is provided within less than 5.5 cm from the blade or from the rear blade.

20. The handle according to claim 16, wherein the opening of the arcs is provided towards the back of the handle.

21. The handle according to claim 20, wherein the number of bowed ribs is from 1 to 12.

22. The handle according to claim 16, wherein the ribs are slightly inclined towards the front of the handle.

23. The handle according to claim 16, wherein the height of a given rib progressively decreases from a greater height at about the middle of the handle seen from above, to a smaller height as the rib extends outwards.

24. The handle according to claim 16, wherein the length of each rib progressively increases from a smaller length backwards of the handle, to a greater length towards the blades and then progressively decreases to a smaller length.

25. The handle according to claim 16, wherein the longitudinal spacing between two adjacent ribs is from 1.0 to 3.6 mm.

26. The handle according to claim 16, wherein the longitudinal thickness of a rib is from 1.0 to 4.0 mm.

27. The handle according to claim 16, wherein a sequence of plastic ribs and of rubber ribs are grouped according to the nature of the material used for their manufacture such as plastic ribs and then rubber ribs.

28. The handle according to claim 15, having a composite structure comprising a substantially rigid backbone of an injected moulded thermoplastic, non elastomeric material and a flexible part made of an injected moulded elastomeric material.

29. A handle provided with an improved grip structure for a razor comprising a rigid plastic part and a compressible part characterized in that the handle comprises bowed ribs provided on an upper side of the handle in the vicinity of a razor head, wherein the center of the ribs are capable of being aligned along the length of the handle and wherein the opening of the arcs is provided towards the back of the handle.

30. A handle provided with an improved grip structure for a razor comprising a rigid plastic part and a compressible part characterized in that the handle comprises bowed ribs provided on an upper side of the handle in the vicinity of a razor head, wherein the center of the ribs are capable of being aligned along the length of the handle, wherein the bowed ribs include shapes like arcs of a circle having between about 90 and about 180 degrees of angle, and wherein the number of bowed ribs is from 1 to 12.
